(19) United States
(12) Patent Application Publication
(10) Pub. No.: US 2002/0181980 A1
(43) Pub. Date: Dec. 5, 2002

(54) Device for removing a coating adhering to an intermediate carrier in an electrophotographic printer or copier device

(76) Inventors: Albrecht Gerstner, Oberbergkirchen (DE); Manfred Viechter, Walpertskirchen (DE)

Correspondence Address: SCHIFF HARDIN & WAITE, 6600 SEARS TOWER, 233 S WACKER DR, CHICAGO, IL, 60606-6473, US

(21) Appl. No.: 10/152,122

(22) Filed: May 21, 2002

(30) Foreign Application Priority Data
May 23, 2001 (DE) 101 25 325.7

(51) Int. Cl. G03G 21/00

(52) U.S. Cl. 399/349

(57) ABSTRACT

In order to remove a coating of toner, abrasion and paper dust adhering to a surface of an intermediate carrier, for example a photoconductor drum, an elastomer-coated drum is provided that rolls off on the intermediate carrier under contact pressure. A contact pressure region having at least one sub-region with slippage between the drum and the intermediate carrier forms in the contact pressure region. A relative velocity at the surface of intermediate carrier results that leads to an erasing effect by means of which the coating is detached from the intermediate carrier

### BACKGROUND OF THE INVENTION

Electrophotographic printer or copier devices are known, for example, from U.S. Pat. No. 6,072,977 or DE 197 49 386 C2, incorporated herein. They comprise a photoconductor drum or a photoconductive band as an intermediate carrier on which an image of the image to be printed on a recording medium, for example a paper web, is generated by charge transfer using a character generator. Subsequently, the intermediate carrier is conducted past a toner station with which the charge image on the intermediate carrier is inked with toner. The toner image is transferred from the intermediate carrier onto the recording medium in a transfer printing station and is fixed thereon in a fixing station. The printing or copying event for an image has thus been ended. The intermediate carrier is discharged and is then available for a new printing or copying event.

In electrophotographic printers or copiers, a coating comprising deposits, for example of toner, paper dust and abrasion, forms on the photoconductive intermediate carrier given longer operation. This coating is usually formed as a film. It must be removed since it deteriorates the printing quality. Such a film also has a negative influence on the service life of the intermediate carrier.

Up to now, the film was removed with cleaning brushes or with a stripper structure referred to as blades. An example of these cleaning methods derives from U.S. Pat. No. 5,832,355, incorporated herein.

Given cleaning brushes, a very hard cleaning brush is required in order to remove the film. As a result thereof, the photoconductor can be scratched, for example given organic photoconductive intermediate carriers on a plastic substrate.

Given a blade, the blade edge was previously utilized for the cleaning. When the edge has become worn, the cleaning effect deteriorates and the blade must be replaced. The cleaning effect is good for loose toner; a film-like coating, in contrast, is difficult to remove.

U.S. Pat. No. 4,252,435 incorporated herein discloses a cleaning device wherein the cleaning of a photoconductor drum occurs with the assistance of a foam rubber drum. The foam rubber drum is driven and rotates in the opposite direction compared to the photoconductor drum. By pressing the drum against the photoconductor drum, air that strips the residual toner from the photoconductor drum is pressed out from the drum. The film-like coating of deposits cannot be removed from the photoconductor drum with such a cleaning device.

A problem underlying the invention is comprised in specifying a device with which the film-like coating can be reliably and gently removed from the intermediate carrier.

### SUMMARY OF THE INVENTION

According to the present invention, a coating of deposits adhering to a surface of a driven intermediate carrier in an electrophotographic printer or copier device is removed. An elastomer-coated, rotatably seated drum is provided that rolls off on the driven intermediate carrier. The drum is pressed against the intermediate carrier such that a contact region arises wherein a surface of the drum is flattened.

### BRIEF DESCRIPTION OF THE DRAWINGS

FIG. 1 is a schematic structure of an electrophotographic printer or copier device;

FIG. 2 is an elastomer-coated drum in a first operating mode;

FIG. 3 shows the combination of a drum and a cleaning device;

FIG. 4 is an excerpt that shows the effective part of the drum in a second operating mode; and

FIG. 5 is an exemplary embodiment with a photoconductor band as intermediate carrier.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

The elastomer-coated drum is pressed against the intermediate carrier such that a contact region (nip) arises. It thereby rolls off on the driven intermediate carrier. It is expedient when the drum itself is not driven. However, it is also possible to decelerate the drum. It is required in all operating modes, however, that the contact region comprises a sub-region wherein there is slippage between drum and intermediate carrier. A relative velocity derives thereat between intermediate carrier and rum at the surface thereof that leads to a type of “eraser effect”. As a result thereof, the coating is released from the intermediate carrier in a gentle way. This eraser effect also has the additional advantage that the drum itself is also cleaned.

The device and the method thus have the following advantages:

The service life of the intermediate carrier, for example of a photoconductor drum, is lengthened;

There is lower wear at the drum; a cost-beneficial cleaning principle thus derives;

The drum cleans itself;

The method is low-maintenance;

the cleaning principle is independent of the coat the be removed;

scratches and striations at the intermediate carrier are prevented due to the rolling.

A soft elastomer can be employed for the surface of the drum. It is expedient when the hardness <70 Shore A is selected. Advantageously, the hardness may lie between 10 and 30 Shore A. Silicone is an elastomer that meets these demands.

It is advantageous when the surface of the drum is closed (closed pore).

It is also advantageous when the drum is combined with a further cleaning device that, for example, can comprise a cleaning brush, of a cleaning drum for cleaning the cleaning brush and a stripper for removing the toner from the cleaning drum.

The device is expediently utilized given a photoconductor drum or a photoconductor band in an electrophotographic printer or copier device. When a photoconductor band is employed as an intermediate carrier, it is expedient when a supporting structure is provided at the side of the photoconductor band facing away from the device. However, the device can also be employed given other drums, for example given a toner delivery drum in a developer station.

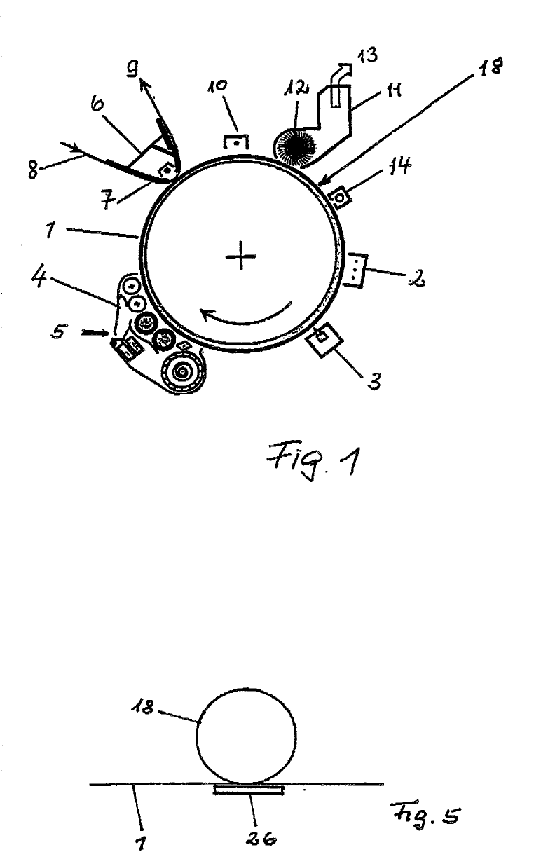

FIG. 1 shows a schematic arrangement of the components in an electrophotographic printer or copier device. An intermediate carrier 1 (a photoconductor drum in FIG. 1; the intermediate carrier can likewise be a photoconductor band) moves past the components with a constant velocity First, the intermediate carrier 1 is charged by a charging corotron 2. The image to be printed is generated on the intermediate carrier as a charge image with sharply focused light using a character generator 3. Subsequently, the charge image is inked with toner 5 in a developer station 4. The toner image, finally, is transferred onto a recording medium 8, for example paper, in a transfer station 6, for example with the assistance of a transfer printing corotron 7, and is then fixed in a fixing station 9 (not shown). Subsequently, the intermediate carrier 1 is electrostatically neutralized with a corotron 10. The residual toner that still adheres to the intermediate carrier 1 is removed for a new image cycle by a cleaning device 11, for example a cleaning brush 12 and extraction unit 13. Finally, the intermediate carrier 1 is exposed by a discharge lamp 14 for improving its long-term behavior. The intermediate carrier 1 is now ready for a new printing cycle.

The cleaning device 11, however, is not suited for removing a film-like coating of deposits such as, for example, residual toner, paper dust or abrasion from the intermediate carrier 1. This problem is solved with the assistance of an elastomer-coated drum that is shown in FIGS. 2-5.

FIG. 2 shows a drum 18 with, for example, a metal core 27 that is coated with an elastomer 19. The drum 18, also called an elastomer drum below and which is rotatably seated, rolls off on the intermediate carrier 1. It is thereby pressed against the intermediate carrier 1 such that a contact region 20 (nip) arises that comprises at least a sub-region 28 (FIGS. 2, 4) with slippage. The function thereof shall be explained later.

The elastomer drum 18 can be utilized such that it itself is not driven. However, it is also possible to decelerate or drive the drum 18. It can also lie obliquely on the intermediate carrier 1. In all of these possibilities of rolling, however, it must be assured that the contact region 20 with the sub-region 28 arises.

In a first operating mode (FIG. 2), the drum is pressed against the intermediate carrier 1 such that the contact region 20 can be subdivided into an entry region 21 (sub-region with slippage), a region 22 without slippage and a discharge region 23 (sub-region with slippage).

In order to meet the demands for loosening the coating, the elastomer drum 18 comprises an elastomer 19 with low hardness (<70 Shore A, preferably 10-30 Shore A). It is thereby beneficial when the surface of the drum is closed.

The elastomer drum 18 then already deforms when pressed against the intermediate carrier 1 with low forces. Due to the deformation of the elastomer 19, a flattening of the drum surface occurs in the contact region 20. The drum radius in the contact region 20 is smaller than in the region without contact. As a result thereof, different surface velocities of the elastomer drum 18 arise. A change in velocity of the surface of the elastomer drum 18 occurs at least at a part of the contact surface 20 compared to the intermediate carrier 1 to be cleaned, which is driven. The surface velocity of the elastomer drum 18 thus changes, and that of the intermediate carrier 1 remains constant. A relative motion thus arises between the surfaces of the elastomer drum 18 and the intermediate carrier 1.

The function is explained on the basis of the operating mode according to FIG. 2. Upon entry of an imaginary point at entry region 21 at the surface of the elastomer drum 18, this is initially decelerated here (entry region 21=sub-region with slippage). It is in turn accelerated in the discharge region 23 (sub-region with slippage). In contrast thereto, no slippage occurs in the middle region 22 since the elastomer drum 18 has a high coefficient of friction. However, relative velocities (slippage) derive in the entry region 21 and in the discharge region 23, these leading to regions with micro-friction, the “erasing effect”, that strips the film-like coat 24.

In this cleaning procedure, the elastomer drum is slightly occupied with coating particles. The described “erasing effect”, however, results in these particles in turn being stripped from the elastomer drum 18. The elastomer drum 18 is thus self-cleaning.

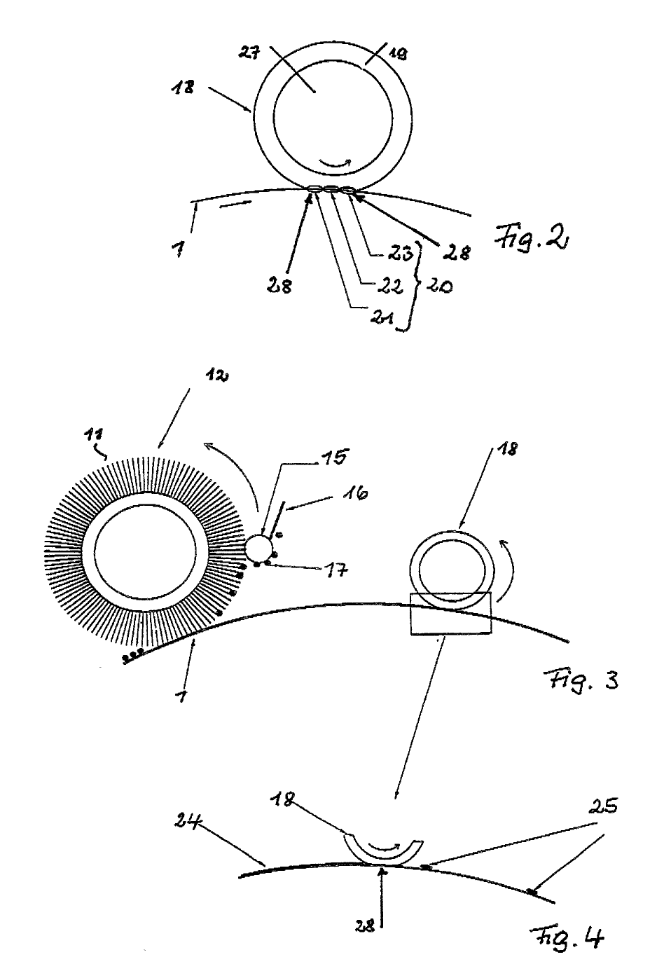

FIG. 3 shows the combination of elastomer drum 18 and a cleaning device 11. The elastomer drum 18, for example, follows the cleaning device (this is indicated in FIG. 1 by an arrow that shows the position of the elastomer drum 18). Advantageously, the cleaning device 11 comprises a cleaning brush 12, a cleaning drum 15 and stripper 16. The cleaning drum 15 removes residual toner 17 from the cleaning brush 12. This residual toner 17 is removed from the cleaning drum 15 by the stripper 16.

The film-like coating (referenced 24 in FIG. 4) remaining on the intermediate carrier 1 behind the cleaning device 11 is now stripped by the elastomer drum 18. This function of the elastomer drum 18 is explained on the basis of FIG. 4, which is an excerpt from FIG. 3 wherein the contact region 20 comprises only one sub-region 28 with slippage (second operating mode). The film-like coating 24, which has not been removed by the cleaning device 11, is detached from the intermediate carrier 1 by the described erasing effect of the sub-region 28 and is loosened to form fine residual particles that now adhere to the intermediate carrier 1 with only slight forces. With the next revolution of the intermediate carrier 1, for example, the cleaning device 11 removes these residual particles 25 from the intermediate carrier 1. This function, of course, also occurs in the first operating mode.

Any elastomer that exhibits the aforementioned hardness can be employed as a surface of the drum 18. Silicone has proven especially advantageous.

When a photoconductor band is employed as intermediate carrier 1, it is expedient to arrange a support 26 opposite the elastomer drum 18 in order to achieve the contact pressure required for the function (see FIG. 5).

While preferred embodiments have been illustrated and described in detail in the drawings and foregoing description, the same are to be considered as illustrative and not restrictive in character, it being understood that only the preferred embodiments have been shown and described and that all changes and modifications that come within the spirit of the invention both now or in the future are desired to be protected.

We claim as our invention:

1. A device for removing a coating of deposits adhering to a surface of a driven intermediate carrier in an electrophotographic printer or copier device, comprising:
an elastomer coated, rotatably seated drum that rolls off on the driven intermediate carrier; and
the drum being pressed against the intermediate carrier such that a contact region arises wherein a surface of the drum is flattened.

2. The device according to claim 1 wherein the drum is not driven.

3. The device according to claim 1 wherein the drum is decelerated.

4. The device according to claim 1 wherein the elastomer comprises a hardness of <70 Shore A.

5. The device according to claim 4 wherein the elastomer comprises a hardness of 10-30 Shore A.

6. The device according to claim 4 wherein the elastomer comprises silicone.

7. The device according to claim 1 wherein the surface of the drum is closed.

8. The device according to claim 1 wherein a further cleaning device is provided for cleaning the intermediate carrier of toner.

9. The device according to claim 8 wherein the further cleaning device comprises:
a cleaning brush for cleaning the intermediate carrier;
a cleaning drum for cleaning the cleaning brush; and
a stripper for removing toner from the cleaning drum.

10. The device according to claim 1 wherein the intermediate carrier comprises a photoconductor drum.

11. The device according to claim 1 wherein the intermediate carrier comprises a photoconductor band.

12. The device according to claim 11 wherein a supporting structure is provided at a side of the photoconductor band lying opposite the drum.

13. A device for removing a coating of deposits adhering to a surface of a driven intermediate carrier in an electrophotographic printer or copier device, comprising:
an elastomer coated, rotatably seated drum that rolls off on the driven intermediate carrier; and
the drum being pressed against the intermediate carrier such that a contact region arises wherein a surface of the drum is flattened to create first and second sub-regions each having slippage causing an erasing effect between the drum and the intermediate carrier lying at both sides of an approximate center of the contact region where; and
the contact region lying adjacent and downstream from a further cleaning device.

14. A method for removing a coating adhering to a surface of an intermediate carrier comprising the steps of:
providing elastomer-coated, rotatably seated drum and positioning the drum relative to the intermediate carrier so that it rolls off on the intermediate carrier; and
utilizing a contact region where the drum presses against the intermediate carrier and where a surface of the drum is flattened to remove the coating which is deposited on a surface of the intermediate carrier.

15. A method for removing a coating of deposits adhering to a surface of an intermediate carrier in an electrophotographic printer or copier device, comprising the steps of:
pressing an elastomer coated, rotatable drum against a driven intermediate carrier such that a contact region arises with at least one sub-region with slippage between the drum and the intermediate carrier;
rolling off the drum on the intermediate carrier; and
removing the coating due to friction between the drum and the intermediate carrier in the sub-region.

16. The method according to claim 15 wherein the drum is pressed against the intermediate carrier such that the contact region comprises an entry region as a sub-region with slippage, a region with slippage, and a discharge region as a further sub-region with slippage.

17. A method for removing a coating of deposits adhering to a surface of an intermediate carrier in an electrophotographic printer or copier device, comprising the steps of:
pressing an elastomer coated, rotatable drum against a driven intermediate carrier such that a contact region caused by flattening of the rotatable drum arises with sub-regions with slippage between the drum and the intermediate carrier as a result of a relative velocity;
rolling off the drum on the intermediate carrier; and
removing the coating due to friction between the drum and the intermediate carrier in the sub-region.
